(19) United States
(12) Patent Application Publication
(10) Pub. No.: US 2026/0350322 A1
(43) Pub. Date: Nov. 5, 2026

(54) Computer-Implemented System and Method for Real-Time Moderated Dialogues with AI-Emulated Historical Figures

(71) Applicant: Jason Matthew Roos, Irvine, CA (US)

(72) Inventor: Jason Matthew Roos, Irvine, CA (US)

(73) Assignee: Luminary Lounge, LLC, Irvine, CA (US)

(21) Appl. No.: 19/739,142

(22) Filed: Jul. 13, 2026

Related U.S. Application Data
(63) Continuation of application No. 18/236,961, filed on Aug. 23, 2023, now abandoned.

(51) Int. Cl. G06F 40/40

(52) U.S. Cl. CPC G06F 40/40

(57) ABSTRACT

A computer-implemented method and system for conducting moderated text-based discussions between human users and one or more AI models that emulate historical figures. The one or more AI models generate multiple text message options based on a most recently approved text message within a publicly accessible chat window, with the generated text message options emulating linguistic styles, beliefs, and knowledge attributed to a respective historical figure. The generated text message options are presented within a moderator interface for review. Approval input selecting one of the generated text message options is received via the moderator interface, and the approved text message option is published in the publicly accessible chat window and becomes the most recently approved text message used as a basis for generating subsequent text message options. The system further encompasses automated moderator screening, auto-approval mechanisms for user messages, and multi-moderator control transfer.

### CROSS-REFERENCE TO RELATED APPLICATIONS

This application is a continuation of U.S. patent application Ser. No. 18/236,961, filed Aug. 23, 2023, titled “Computer-Implemented System for Real-Time Moderated Dialogues with AI-Emulated Historical Figures,” the entire disclosure of which is incorporated herein by reference.

### FIELD OF INVENTION.

The present invention relates generally to interactive communication platforms, and more particularly to a computer-implemented system designed to facilitate moderated discussions between human users and artificial intelligence (AI) models representing historical figures.

### BACKGROUND

The field of interactive communication platforms, particularly those involving artificial intelligence (AI), has experienced significant advancements over the years. As AI models evolved, they have been increasingly tasked with mimicking human-like conversations using vast datasets and intricate algorithms, aiming to produce responses that closely resemble human interactions. Among the many applications, these AI models have found utility in roles such as customer support chatbots and platforms designed for general conversational interaction.

A challenging and unique application of these models is their use in replicating the conversation styles of historical figures. These figures, revered for their roles in history, offer unique educational, cultural, and entertainment insights. However, while there have been many attempts to simulate such historical figures, the resulting AI models frequently fall short in several critical areas. Authenticity, for instance, is often compromised, with AI models occasionally generating statements that not only are factually incorrect but also diverge from the established beliefs, attitudes, or behaviors of the represented historical personas.

Engagement, a pivotal metric for the success of interactive platforms, also tends to be limited in existing systems. While users may be initially intrigued by the prospect of conversing with a virtual rendition of a historical figure, this interest can wane as they encounter repetitive, generalized, or depth-lacking responses from the AI. Additionally, in real-time multi-participant discussions, maintaining a coherent thread of conversation is imperative. However, extant models often falter in evolving or multifaceted conversations, producing out-of-context or irrelevant responses.

Another notable challenge lies in the moderation tools provided for real-time discussion systems. Existing tools that incorporate real-time moderation often over-rely on human moderators, failing to provide them with the requisite tools to manage and guide discussions efficiently. This oversight can be particularly taxing during active discussions with numerous participants, leaving moderators overwhelmed. Furthermore, in systems where human expertise, especially concerning historical figures, is paramount, there is frequently an absence of efficient mechanisms to ensure that moderators possess the appropriate knowledge and expertise. Traditional selection processes often succumb to bias, lacking both transparency and consistency.

Lastly, in an era witnessing the ascent of “deepfakes” in visual and audio media, concerns are burgeoning regarding the potential misuse of AI to distort representations of historical figures in textual form. Such distortions carry the risk of disseminating misinformation, further underscoring the necessity for a robust and genuine interactive platform.

Given these limitations, there exists a palpable need for a system that can harness the power of AI to facilitate genuine, coherent, and deeply engaging discussions with representations of historical figures, all while ensuring expert moderation and authenticity in the interactions. This invention is motivated by and seeks to address these pressing challenges in the realm of interactive AI platforms.

It is within this context that the present invention is provided.

### SUMMARY

The present invention introduces an innovative computer-implemented system designed to streamline and enhance moderated discussions between human users and AI models that emulate historical figures. The salient feature of this invention concentrates on the method of seamlessly integrating one or more AI models into a chat, working alongside human participants and at least one expert moderator, to ensure authenticity and coherence in the dialogue.

Central to the invention's functionality is the real-time moderation process. In this design, each AI model participating in the chat generates multiple text message options in response to the flow of conversation. These potential responses are based on the most recently approved text messages visible within a public chat window. The system is configured to ensure that each AI model's generated responses closely emulate the linguistic styles, beliefs, and knowledge attributed to the respective historical figure.

To maintain the integrity and continuity of the conversation, the invention presents these AI-generated response options within a distinct “moderator window,” accessible solely to the designated moderator. Within this window, the moderator has the discretion to review, edit, and approve the most contextually appropriate and historically accurate message from among the proposed AI-generated options. Once a message receives the moderator's approval, it is then published in the publicly visible chat window, thereby becoming the new point of reference for subsequent AI-generated message options.

Moreover, to foster coherence and ensure real-time relevance, the system automates the exclusion of AI-generated message options that preceded the latest approved message, as they would no longer align with the current direction of the conversation.

In essence, the present invention offers a methodological breakthrough for conducting moderated discussions with AI models representing historical figures. By employing a two-window approach—a publicly visible chat for participants and a distinct moderator window for message vetting—the system ensures that the dialogue with historical figures remains engaging, coherent, and historically authentic.

### BRIEF DESCRIPTION OF THE DRAWINGS

Various embodiments of the invention are disclosed in the following detailed description and accompanying drawings.

FIG. 1A-C visualizes various interface screens during the historical figure-specific testing process for potential moderators, emphasizing the question-prompting mechanism, response input, and time-based constraints.

FIG. 1D-E illuminates contrasting outcomes post-test, delineating both successful and unsuccessful attempts and providing feedback.

FIG. 2 represents the specialized dashboard for moderators, catering to their distinct role within the system.

FIG. 3A-H sequentially illustrates various stages of an AI-assisted chat conversation, capturing the progression of interactions, message approvals, moderator interventions, and addition of new AI participants.
3A: Chat commencement with historical figure greetings suggested to the moderator.
3B: Approved greeting from George Washington visible in the public chat.
3C: Message suggestions evolve in reaction to the approved George Washington greeting.
3D: Lincoln's greeting is approved, prompting a response suggestion from Washington.
3E: The moderator's direct intervention and message introduction in the chat.
3F: Evolution of chat with moderator's message and dynamic dismissal of irrelevant AI suggestions.
3G: Incorporation of a third AI figure, Benjamin Franklin, and utilization of AI-assistance for user responses.
3H: A user's initial message under scrutiny, indicating the system's default auto-approval mechanism.

FIG. 4 showcases the perspective of a secondary moderator joining a live chat and requesting moderating control over select AI models.

FIG. 5 highlights the moderator interface transitioning into “away from keyboard” mode, emphasizing the criticality of prompt moderator interventions for chat authenticity.

FIG. 6 depicts a flowchart of the process of moderated AI chat interactions.

FIG. 7 depicts a more detailed process flowchart for message review and approval on the chat platform.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terminology used herein is for the purpose of describing particular embodiments only and is not intended to be limiting.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

### Description Of Preferred Embodiment

The present invention provides an advanced system and method for conducting moderated chat sessions, seamlessly integrating AI chatbots representing historical figures. The foundational architecture of the system comprises one or more servers communicating with user devices, with

a unique distinction between devices operating under moderator permissions and those of general participants. The system and methods are designed to preserve the integrity and authenticity of the chat sessions, emphasizing the coalescence of human expertise and advanced AI capabilities.

Upon initiation of a chat session, the moderator, via their respective device, introduces one or more AI chatbots into the chat environment. These AI chatbots, equipped with vast knowledge databases and sophisticated natural language processing capabilities, personify historical figures, generating textual responses reflective of the historical figure's persona, knowledge, and mannerisms.

For each incoming message in the chat window, particularly the most recent approved text message, the AI chatbot formulates multiple potential responses. These potential responses are then queued in a specialized moderation window, exclusive to the human moderator's interface. This design decision is pivotal in ensuring that AI-generated responses undergo human scrutiny and filtering, preserving the conversation's genuineness.

The moderator, equipped with the necessary expertise and permissions, then reviews and approves a selected response from the presented options. Upon approval, this selected response is displayed in the publicly visible chat window. This curated interaction ensures that the chat remains dynamic, with the progression anchored by the moderator's discernment, thus limiting the potential for errant or out-of-context AI-generated inputs.

The system also implements preemptive measures, where messages preceding the most recently approved message are systematically dismissed from consideration. This ensures relevance in ongoing conversations, minimizing the potential for outdated or contextually inappropriate responses.

While the primary focus revolves around the intricate dance between AI-generated responses and human moderation, the system encompasses other intricate features. These include an automated, AI-driven screening process for potential moderators, leveraging a series of timed, encrypted, open-ended questions; audience participation elements; and AI-curated educational content, enhancing user engagement and fostering a richer learning environment.

### Description Of Drawings

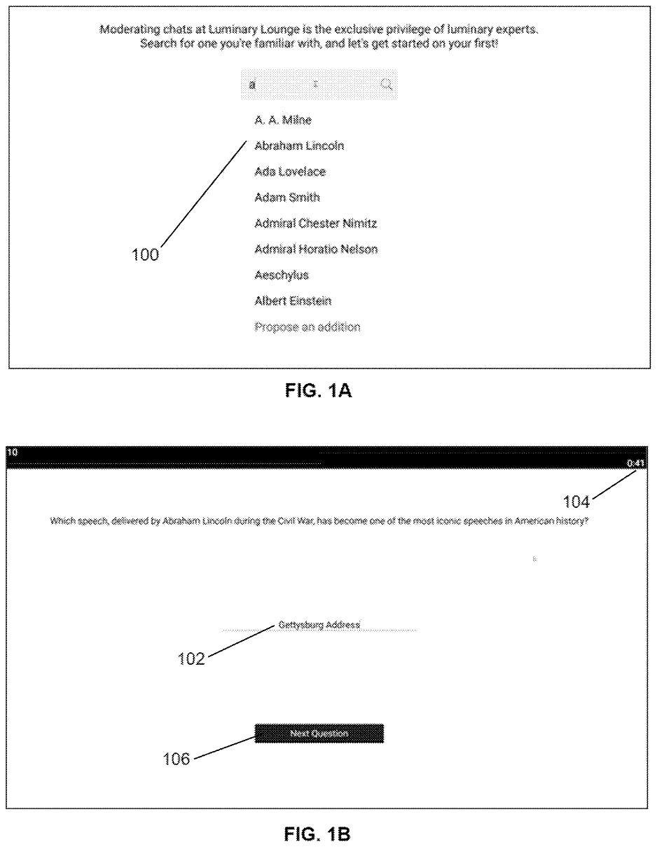

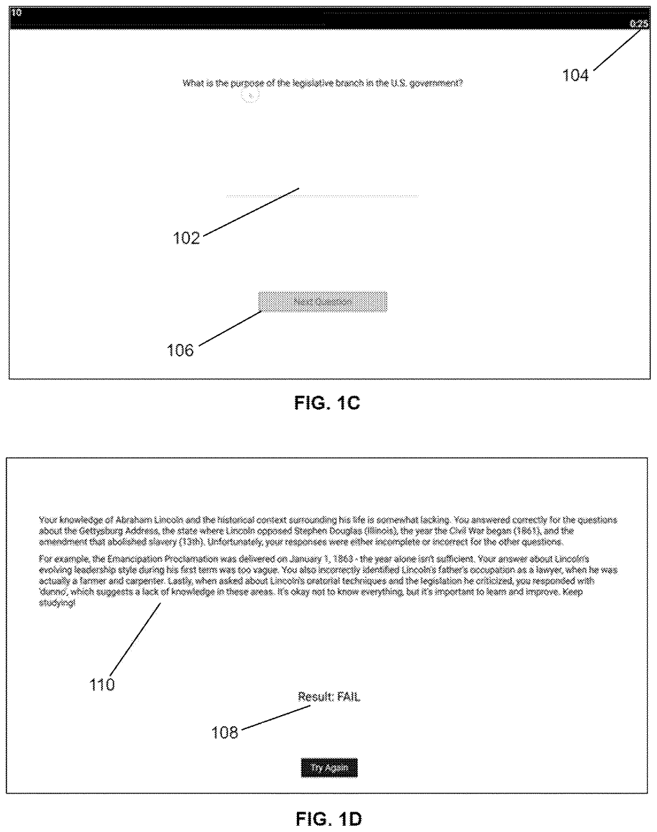

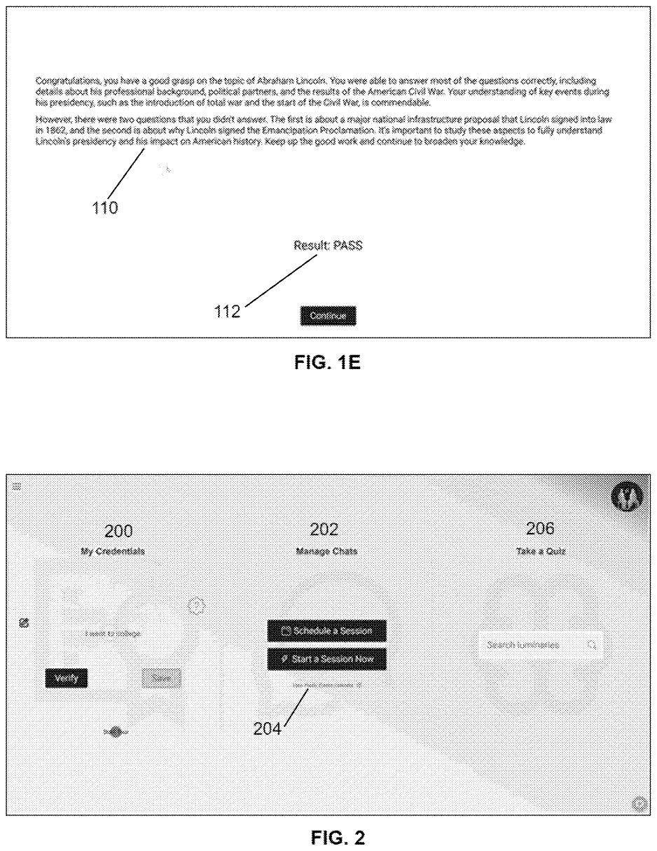

FIGS. 1A through 1E depict interfaces within the system that a prospective moderator encounters during the evaluation process for expertise on a specific historical figure.

FIG. 1A displays an interface directing a user to select a historical figure. A dropdown or list 100 provides a range of predefined historical figures for user selection, facilitating an uncomplicated start to the examination process.

In FIG. 1B, the interface presents an open-ended question about Abraham Lincoln. Central to this is the input textbox 102, designed for answer submission. A notable component is the quiz timer 104, prominently displayed, counting down from one minute. This timer is server-controlled, promoting timely user responses. Anti-cheating mechanisms are in place: encrypted question dispatch, one-question-at-a-time protocol, and disabling of copy-paste functionalities, ensuring genuine answers.

FIG. 1C shows another examination phase. The textbox 102 is now empty and ready for input. The presented question centers on US law. The “Next Question” button 106 is deactivated (grayed out), prohibiting advancement until an answer is provided. The diminishing timer 104 underscores the importance of prompt answers.

FIG. 1D shows an interface where the AI determines the user's response as inadequate. The screen predominantly features a failure notification 108. Instead of mere rejection, detailed feedback 110 identifies where user responses misaligned with expectations.

FIG. 1E shows a successful test outcome with a pass notification 112. Despite the achievement, feedback 110 points out areas for refinement. A confirmation indicator validates the user's ability to moderate for the selected historical figure. Consequently, the system updates the user dashboard with the new credentials, enabling a smooth transition to a certified moderator status within the platform.

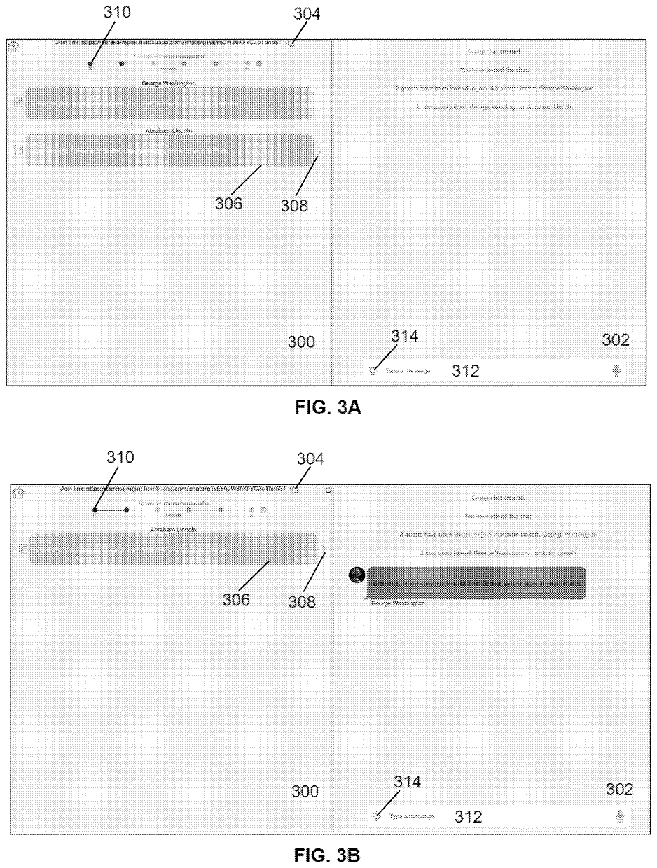

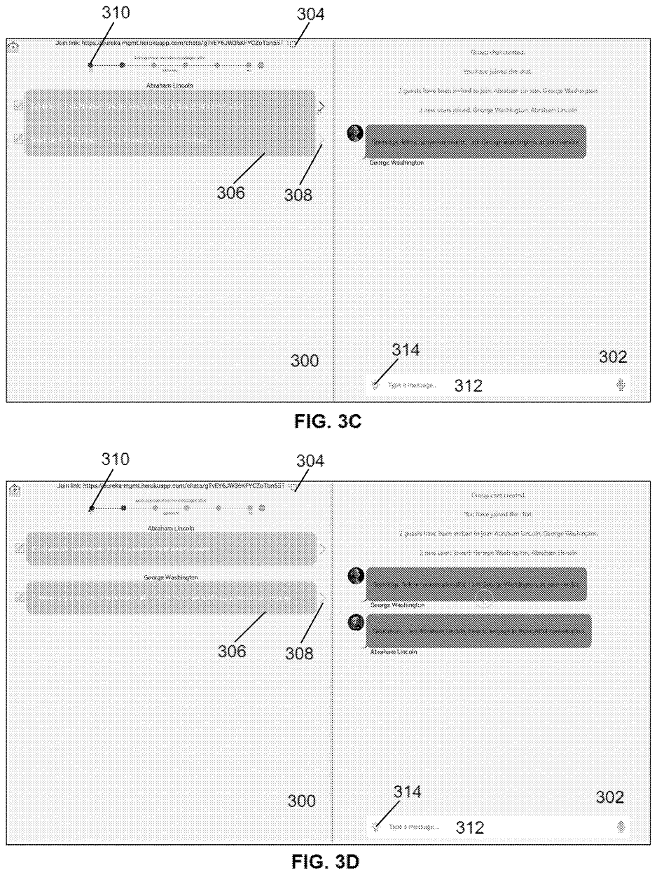

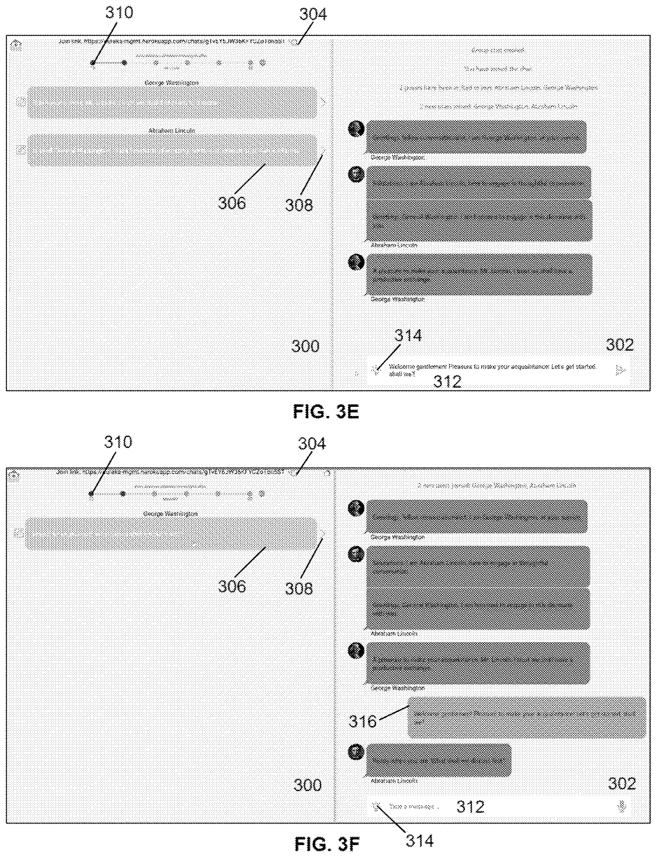

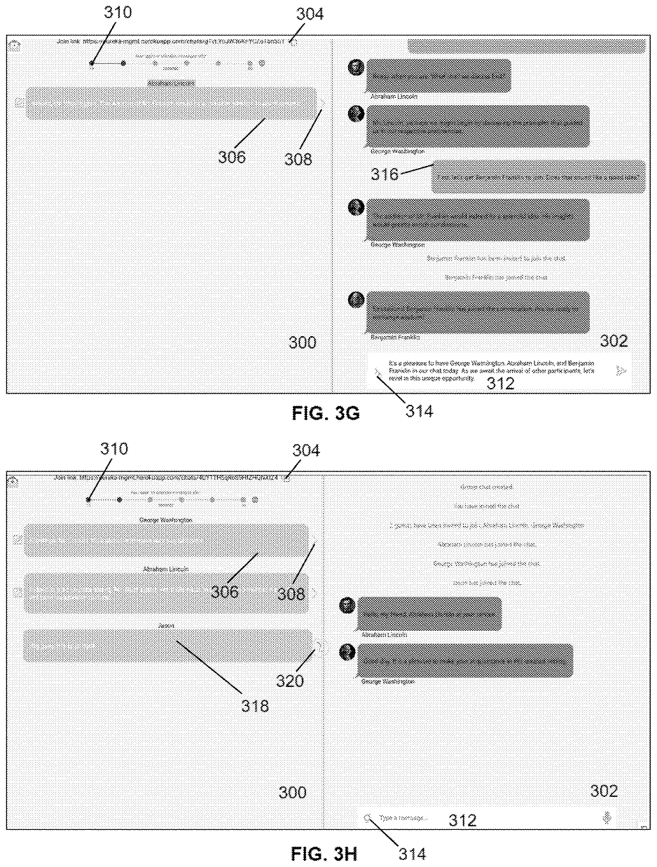

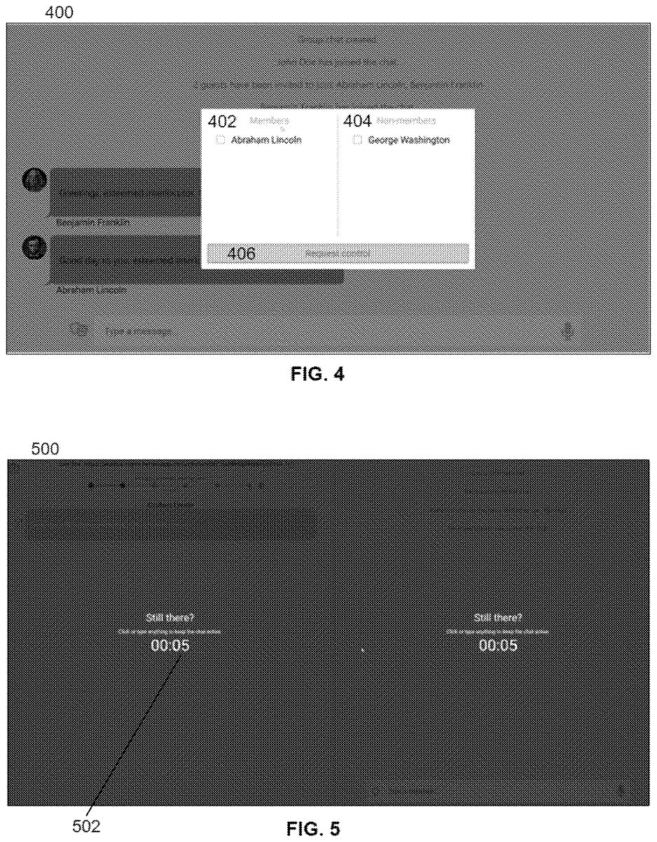

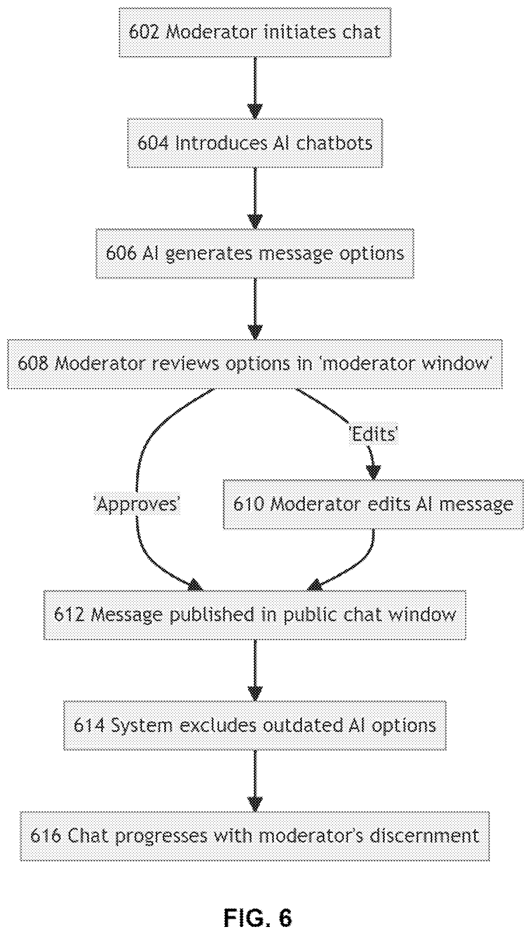

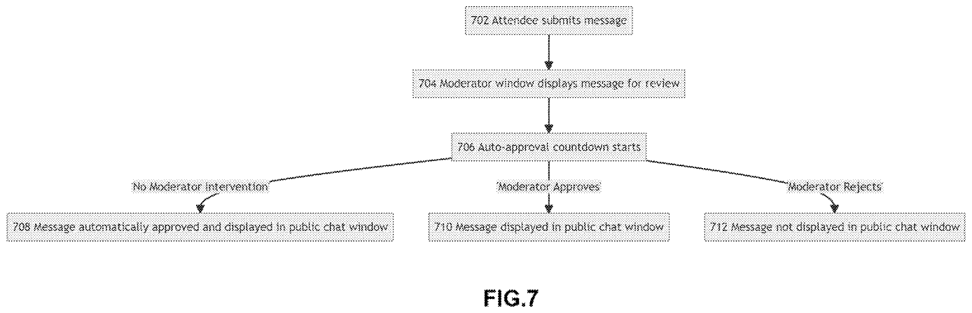

FIG. 2 shows the user dashboard designed specifically for moderators within the system. This interface integrates various features addressing a moderator's operational requirements.

On the left side of the screen is the “My Credentials” section 200. This section provides a concise interface for users to input, modify, and validate their professional and academic qualifications.

The center of the screen houses the “Manage Chats” section 202. This central function enables moderators to coordinate their chat sessions. The section provides two distinct options: scheduling a chat session for a later date and time, and initiating an immediate chat session. An integrated calendar link 204 offers an overview of the platform's upcoming chat sessions, facilitating strategic planning for moderators.

On the right side of the dashboard lies the “Take a Quiz” section 206. This section enables moderators to explore and qualify for new historical figures by taking associated quizzes. Through its search function, users can identify and select historical figures they aspire to moderate for.

FIG. 3A-3G show the stages of a conversation from the viewpoint of a moderator, featuring both a private moderation window 300, visible only from the moderator user interface, and a public chat window 302 visible to all.

In FIG. 3A, the initialized chat consists of the AI models of George Washington and Abraham Lincoln alongside the moderator. The private window 300 displays a web link 304 for inviting participants directly into the chat. Both AI entities present their suggested messages 306 (initial greetings in this case) with navigational arrows 308 to shift between alternatives. The auto-timer slider 310 in the private moderation window 300 is set at 30 seconds. The public window 302 comprises a text box 312 for the moderator to enter their own messages into the chat, which has a light-bulb symbol 314 visible which, when clicked, will cause an AI generated message to appear in the text box 312 ready for submission.

Proceeding to FIG. 3B, George Washington's suggested message 306, having been selected from among multiple options and approved by the moderator, now appears in the public chat window 302.

FIG. 3C shows the Abraham Lincoln AI suggesting a subsequent response 306 in the private window 300, a reaction to George Washington's message in the public chat. Since an initial greeting would still be appropriate at this stage, Abraham Lincoln's initial greeting suggestion 306 remains visible also.

Within FIG. 3D, Abraham Lincoln's greeting, post approval by the moderator, moves from the private window 300 to the public chat 302. Subsequently, the George Washington AI proposes a new response 306 in the private window 300.

In FIG. 3E, the approved conversation between George Washington and Abraham Lincoln continues in the public chat, each approved response generating new suggestions from one another, but the moderator is now typing their own message in the chat input box 312.

FIG. 3F displays the moderator's message 316 as part of the public chat 302. As a result of the moderator introducing a shift in the conversation, the now redundant suggested messages from both the George Washington AI and the Abraham Lincoln AI now vanish from the private window 300 and a new suggested message appears in response to the moderator's message 316.

Finally, in FIG. 3G the moderator invites a third AI model-Benjamin Franklin's AI representation—into the chat mix. The moderator has also made use of the advanced feature mentioned above, clicking the light-bulb symbol 314 to cause another AI model to draft a response on their behalf in the text box 312.

FIG. 3H details an interface consistent with those shown in FIGS. 3A-3G, but at the start of a new chat conversation where a platform user has joined the chat and submitted a message 318. This message is displayed in the moderator window for review. Adjacent to the user's message is a progress bar 320, indicating the auto-approval countdown set at a default of 30 seconds. If this timer runs its course without intervention, the user's message will be automatically approved and displayed in the main chat window.

The moderator has the option to manipulate the auto-timer slider 310 to extend the time before auto-approval or deactivate the auto-approval feature entirely. This provides the moderator with flexibility to control the flow and content of the chat session.

FIG. 4 shows the user interface 400 as perceived by a second moderator, who has subsequently joined an ongoing chat session. At 402, a “members” column is distinctly illustrated. This column lists the AI models that are currently participants in the chat session, which at present includes Abraham Lincoln. Adjacent to the “members” column, at 404, is the “non-members” column. This column enumerates the AI models that are available for participation but have not been actively integrated into the current chat. George Washington is listed here, indicating that he is not a current participant but is available for inclusion. When the second moderator clicks “Request Control” 406, the system will send a request to the original moderator for permission to assume moderating control over the selected AI model.

FIG. 5 presents the moderator interface 500 that transitions into an “away from keyboard” (AFK) mode, specifically designed to address periods of moderator inactivity. The function ensures that any period of inactivity is promptly addressed to preserve the quality and authenticity of ongoing conversations. Displayed in the center of the interface is the AFK timer, designated by numeral 502. This digital timer counts down, providing a real-time representation of the duration the moderator has remaining before the chat session is automatically terminated due to prolonged inactivity.

The system's underlying logic, as inferred from the design, ensures that the time window before entering the AFK mode is kept short. This preemptive measure guarantees that conversations remain tightly moderated and are not jeopardized by inadvertent lapses in moderator attention.

FIG. 6 depicts the process of moderated AI chat interactions. The process starts when the “Moderator initiates chat” 602. This can be a planned or spontaneous chat session. In the “Introduces AI chatbots” 604 step, AI personalities relevant to the chat's theme are brought into the session. The AI then “generates message options” 606, presenting several potential responses based on the ongoing conversation.

The moderator “reviews options in ‘moderator window’” 608. This private interface allows the moderator to evaluate AI suggestions, ensuring they fit the chat's context. If an AI suggestion is deemed appropriate, the “Approves” path is taken, leading to the “Message published in public chat window” 612. Alternatively, if the suggestion needs adjustment, the “Edits” path leads to the “Moderator edits AI message” 610, where tweaks are made before publishing.

After a decision is made on an AI suggestion, the “System excludes outdated AI options” (614) to prevent repetition and ensure chat fluidity.

The process continues in “Chat progresses with moderator's discernment” 616, emphasizing the moderator's ongoing role in guiding the conversation.

FIG. 7 depicts a more detailed process flow for message review and approval on the chat platform.

Upon submission of a message by an attendee, indicated as 702, the message is routed to a moderator's review window, as shown by 704. This initial phase ensures that each message undergoes a preliminary review. Immediately after its display in the moderator's window, an auto-approval countdown is initiated, referenced by 706. This countdown establishes a predetermined window for potential moderator action.

From the initiation of the countdown at 706, there are three possible outcomes: In the absence of moderator action during the countdown, the system will default to auto-approval. The message then proceeds to 708, where it's made visible in the public chat window. If the moderator manually validates the message within the countdown's timeframe, the message is advanced to 710 and subsequently displayed in the public chat window. If the moderator opts to decline the message, the process leads to 712, ensuring that the message is withheld from the public chat, effectively blocking any unsuitable or irrelevant content.

### Applications of the Disclosed Method and System

Education and Academia: The invention has transformative potential in the realm of education. For instance, history teachers can leverage this system to enliven their lessons. By bringing historical figures “to life” through the system's interactive platform, educators can deepen students' understanding and enhance their engagement levels. This immersive experience is not confined to history. Educators from diverse fields, ranging from mathematics and science to politics, can utilize this tool, inviting historical figures to share their specialized insights.

Another profound application is in thesis and research support. Students and scholars can engage in dialogues with relevant historical personalities, deriving unique viewpoints that could prove invaluable in their research pursuits. The dynamic nature of the system also paves the way for virtual academic conferences. Institutions can host these events, featuring AI-representations of historical figures who participate in contemporary discussions, adding depth and a historical perspective to modern debates.

Entertainment and Media: In the media and entertainment sector, the system presents opportunities for interactive talk shows. Media outlets can orchestrate segments wherein audiences direct questions to AI-simulated historical luminaries, effortlessly blending education with entertainment. Additionally, the gaming industry can leverage the system to create captivating narratives. By allowing players to converse and collaborate with historical figures, games can present challenges rooted in historical or imaginative scenarios, enhancing the player's immersive experience.

Tourism and Cultural Engagement: For the tourism sector and cultural institutions, the system offers a fresh perspective on historical reenactments. Rather than traditional methods, entities can design virtual experiences, letting enthusiasts and tourists engage firsthand with personalities from yesteryears. Furthermore, museums and libraries can amplify their visitor experience. By integrating the system into interactive kiosks, guests can engage in enlightening conversations with historical figures pertinent to exhibits or literary masterpieces.

Strategy and Policy-making: In strategy formulation and policy-making, the invention shines as a repository of historical wisdom. Imagine strategists and policymakers convening sessions with notable figures from the past, drawing upon their experiences and insights to address modern-day challenges. Such virtual brain trust sessions can offer innovative solutions, anchored in the wisdom of the ages.

Corporate Training and Development: For corporate entities, the system can revolutionize training modules. By setting up sessions where employees converse with celebrated leaders of the past, the system offers lessons in leadership, decision-making, and crisis navigation. Similarly, workshops that dive into ethical challenges can be enriched. Employees can discuss complex moral dilemmas with historical figures revered for their ethical values, ensuring a well-rounded understanding of the topic.

Public Engagement and Awareness: Public awareness campaigns, especially those tied to historical or cultural themes, can immensely benefit from the system. By facilitating interactive exchanges with relevant historical figures, public engagement can be heightened, making the campaigns more impactful.

Personal Development and Lifelong Learning: On an individual level, the system serves as a conduit for personal growth. Lifelong learners can regularly engage with historical figures, continuously expanding their horizons. Additionally, those in pursuit of guidance can turn to the system for mentorship sessions. Engaging with figures renowned for their expertise in specific fields can offer invaluable insights and advice, aiding the user's personal and professional journey.

### Network Components

A server as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memory units. Accordingly, the aforementioned computer systems may include one or more memory units. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memory units may store computer executable instructions that, when executed by the one or more processors, cause the one or more processors to implement the procedures and techniques described herein. The one or more processors may be operably associated with the one or more memory units so that the computer executable instructions can be provided to the one or more processors for execution. For example, the one or more processors may be operably associated to the one or more memory units through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner, as described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components such as software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system have been described in a specific manner referring to the illustrated embodiments, it is understood that the present invention can be applied to a wide variety of solutions that fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for conducting a moderated text-based discussion between one or more human users and one or more AI models that emulate historical figures, the method comprising:
maintaining a publicly accessible chat window displaying approved text messages;
generating, by the one or more AI models, multiple text message options based on a most recently approved text message visible within the publicly accessible chat window, wherein the generated text message options emulate linguistic styles, beliefs, and knowledge attributed to a respective historical figure;
presenting the generated text message options within a moderator interface, the moderator interface being accessible to a designated moderator;
preventing any of the generated text message options from being displayed in the publicly accessible chat window unless approval input is received via the moderator interface;
receiving, via the moderator interface, the approval input from the designated moderator, the approval input selecting one of the generated text message options; and
publishing the approved text message option in the publicly accessible chat window, the approved text message option thereby becoming the most recently approved text message and being used as a basis for generating subsequent text message options.

2. The method of claim 1, wherein one or more text message options that preceded the most recently approved text message are excluded from consideration for subsequent approval.

3. The method of claim 1, further comprising the designated moderator editing the selected text message option prior to the publishing.

4. The method of claim 1, further comprising:
receiving a message submitted by a human user of the one or more human users;
displaying the message in the moderator interface for review;
initiating an auto-approval countdown; and
in the absence of moderator action during the auto-approval countdown, automatically approving the message and displaying the message in the publicly accessible chat window.

5. The method of claim 4, wherein the designated moderator manually validates the message within the auto-approval countdown causing the message to be displayed in the publicly accessible chat window, or declines the message causing the message to be withheld from the publicly accessible chat window.

6. The method of claim 1, wherein unapproved text message options are not provided to the one or more AI models, and wherein text message options, once approved and published in the publicly accessible chat window, are provided to the one or more AI models for generation of subsequent text message options.

7. The method of claim 1, wherein a decision by the designated moderator to approve, edit, or ignore a presented text message option directly affects a progression and thematic direction of the moderated text-based discussion.

8. The method of claim 1, further comprising performing an automated screening process for the designated moderator by presenting a timed series of AI-generated, open-ended questions encompassing key aspects of a historical figure's life, achievements, and field of specialty.

9. The method of claim 1, further comprising generating, by one of the one or more AI models, a text message on behalf of the designated moderator for submission by the designated moderator in the publicly accessible chat window.

10. The method of claim 1, further comprising:
a second moderator joining the moderated text-based discussion; and
responsive to a request from the second moderator, transferring moderating control over one or more historical-figure participants emulated using one or more AI models from the designated moderator to the second moderator, subject to permission from the designated moderator.

11. The method of claim 1, further comprising monitoring a duration of moderator inactivity and automatically terminating the moderated text-based discussion upon the duration exceeding a predetermined limit.

12. The method of claim 1, wherein the moderated text-based discussion is one of a spontaneous chat session or a scheduled chat session integrated with a linked calendar event.

13. The method of claim 1, further comprising enabling the one or more human users to vote or influence a direction and thematic flow of the moderated text-based discussion.

14. A computer-implemented system for facilitating moderated text-based discussions between human users and one or more artificial intelligence (AI) models that emulate historical figures, the system comprising:
one or more servers communicating with a plurality of user devices, the one or more servers configured to:
maintain a publicly accessible chat window displaying approved text messages;
generate, by the one or more AI models, multiple text message options based on a most recently approved text message within the publicly accessible chat window, wherein the generated text message options emulate linguistic styles, beliefs, and knowledge attributed to a respective historical figure;
present the multiple text message options within a moderator interface, the moderator interface being accessible to a moderator;
prevent any of the generated text message options from being displayed in the publicly accessible chat window unless approval input is received via the moderator interface; and
responsive to receiving the approval input selecting one of the generated text message options, publish the approved text message option in the publicly accessible chat window;
wherein the plurality of user devices are configured to access the publicly accessible chat window, and wherein a subset of the plurality of user devices, when operated by the moderator, are configured to access the moderator interface.

15. The system of claim 14, wherein the one or more servers are further configured to exclude from consideration for subsequent approval one or more text message options that preceded the most recently approved text message.

16. The system of claim 14, wherein the one or more servers are further configured to enable the moderator to edit the selected text message option prior to publication in the publicly accessible chat window.

17. The system of claim 14, wherein the one or more servers are further configured to display a message submitted by a human user in the moderator interface for review, initiate an auto-approval countdown, and in the absence of moderator action during the auto-approval countdown, automatically approve and display the message in the publicly accessible chat window.

18. The system of claim 14, wherein the moderator, upon initiating the moderated text-based discussion, selects from a list of historical figures emulated using one or more AI models, the selection being limited to historical figures for which the moderator has been certified by the system.

19. The system of claim 14, wherein the one or more servers are further configured to enforce a duration limit for moderator inactivity, and upon the duration limit being exceeded, automatically terminate the moderated text-based discussion.

20. The system of claim 14, wherein the one or more servers are further configured to enable a second moderator to join the moderated text-based discussion and request transfer of moderating control over one or more historical-figure participants emulated using one or more AI models, the transfer being subject to permission from the moderator.

21. The system of claim 14, wherein the one or more servers are further configured to generate, by one of the one or more AI models, a text message on behalf of the moderator for submission by the moderator in the publicly accessible chat window.
